(19) United States
(12) Patent Application Publication
(10) Pub. No.: US 2026/0263926 A1
(43) Pub. Date: Sep. 10, 2026

(54) GAME INTERACTION CONTROL METHOD AND APPARATUS, AND ELECTRONIC DEVICE

(71) Applicant: NETEASE (HANGZHOU) NETWORK CO., LTD., Hangzhou, Zhejiang (CN)

(72) Inventors: Dachao LI, Hangzhou, Zhejiang (CN); Chengzhi WANG, Guangzhou, Guangdong (CN)

(73) Assignee: NETEASE (HANGZHOU) NETWORK CO., LTD., Hangzhou, Zhejiang (CN)

(21) Appl. No.: 18/998,536

(22) PCT Filed: Apr. 27, 2023
(86) PCT No.: PCT/CN2023/091341

§ 371 Date: Nov. 6, 2025

(30) Foreign Application Priority Data
Aug. 5, 2022 (CN) 202210938031.6

(51) Int. Cl. A63F 13/52; A63F 13/5372; A63F 13/822

(52) U.S. Cl. CPC A63F 13/52; A63F 13/5372; A63F 13/822

(57) ABSTRACT

A game interaction control method, comprising: in response to a model level upgrade event in respect of a first building model, determining a first land parcel where the first building model is located, and determining a connected plot of the first land parcel, wherein the connected plot is directly or indirectly communicated with the first land parcel (S102); and on the basis of building attributes of the upgraded first building model, updating resource attributes of the connected plot (S104). After a building model in a scene is upgraded, resource attributes of other land parcels communicated with the land parcel where the building model is located will be updated. A player can be guided to make an occupied land parcel communicated, thereby heightening the interest of the player in occupying a low-level land parcel and increasing the utilization rate of a game scene map.

### CROSS REFERENCE TO RELATED APPLICATIONS

The present application is a U.S. National Stage of International Application No. PCT/CN2023/091341, filed on Apr. 27, 2023, which claims the priority of the Chinese patent application with an application number of 202210938031.6, filed on Aug. 5, 2022, and titled by “Game interaction control method and apparatus, and electronic device”, the entire contents of both of which are incorporated herein by reference for all purposes.

### TECHNICAL FIELD

The present disclosure relates to the technical field of game, and in particular, to a game interaction control method and apparatus, and an electronic device.

### BACKGROUND

In a simulation game (SLG, strategy game), the game scene is divided into multiple plots, and the plots have different levels. When a player's character level is low, it can only occupy a low-level plot. As the character level gradually increases during participating in the game, it can occupy a high-level plot.

### SUMMARY

According to an aspect of the present disclosure, a game interaction control method is provided, where a graphical user interface is provided by a terminal device, a scene screen of a game scene is displayed in the graphical user interface, the game scene includes a plurality of plot units, and at least a part of the plurality of plot units has a first building model thereon; where the method may include: in response to a model level upgrade event of the first building model, determining a first plot where the first building model is located, and determining a connected plot of the first plot; where the connected plot is directly or indirectly connected to the first plot; and updating a resource attribute of the connected plot based on a building attribute of the upgraded first building model.

According to an aspect of the present disclosure, a game interaction control apparatus is further provided, where a graphical user interface is provided by a terminal device, a scene screen of a game scene is displayed in the graphical user interface, the game scene includes a plurality of plot units, and at least a part of the plurality of plot units has a first building model thereon; where the apparatus includes: a first determining module, configured to determine a first plot where the first building model is located and determine a connected plot of the first plot, in response to a model level upgrade event of the first building model; where the connected plot is directly or indirectly connected to the first plot; and a resource attribute updating module, configured to update a resource attribute of the connected plot based on a building attribute of the upgraded first building model.

According to an aspect of the present disclosure, an electronic device is further provided, where the electronic device includes a processor and a memory, the memory stores machine-executable instructions that can be executed by the processor, and the processor executes the machine-executable instructions to implement the game interaction control method in the embodiments of the present disclosure.

According to an aspect of the present disclosure, a machine-readable storage medium is further provided, which stores machine-executable instructions, where the machine-executable instructions, when being called and executed by a processor, cause the processor to implement the game interaction control method in the embodiments of the present disclosure.

### BRIEF DESCRIPTION OF THE DRAWINGS

FIG. 1 is a flow chart of a game interaction control method provided by an embodiment of the present disclosure;

FIG. 2 is a schematic diagram of a first display format provided by an embodiment of the present disclosure;

FIG. 3 is a schematic diagram of a flowing light special effect provided by an embodiment of the present disclosure;

FIG. 4 is a schematic diagram of another flowing light special effect provided by an embodiment of the present disclosure;

FIG. 5 is a schematic diagram of a road model provided by an embodiment of the present disclosure;

FIG. 6 is a schematic diagram of a plot state provided by an embodiment of the present disclosure;

FIG. 7 is a schematic structural diagram of a game interaction control apparatus provided by an embodiment of the present disclosure;

FIG. 8 is a schematic structural diagram of an electronic device provided by an embodiment of the present disclosure.

### DETAILED DESCRIPTION

In order to make the purposes, technical solutions and advantages of the embodiments of the present disclosure clearer, the technical solutions of the present disclosure will be clearly and thoroughly described below with reference to the accompanying drawings. Obviously, the described embodiments are a part of the embodiments of the present disclosure, rather than all of the embodiments. Based on the embodiments in the present disclosure, all other embodiments obtained by those skilled in the art without making creative efforts fall within the scope of protection of the present disclosure.

In war strategy games, the areas to be contested in the game scene are usually displayed in the form of plots. For example, in the scene of an Immortal Conquest like game, the scene is divided into multiple plots, and players compete for resources by occupying individual plots. The plots are pre-set with different levels, and each level of plot provides a different bonus to resource output. It is generally designed to let players start from low-level plots with fewer resources, and gradually improve their character levels so that they can occupy higher-level plots that offer more resources. However, as the players' game characters progress, low-level plots gradually lose their gameplay value. At the same time, most war strategy games limit the number of plots occupied by players, resulting in players having low interest in occupying low-level plots in the later stages of the game, which results in low map utilization.

That is, when the character level is relatively high, low-level plots are less valuable to the player and also take up the player's quota of occupiable land, leading to a loss of interest in occupying the low-level plots. However, low-level plots account for a significant portion of the game scene.

If a large number of low-level plots remain unoccupied, the map utilization rate of the game scene becomes relatively low and computing resources are wasted.

Based on this, the embodiments of the present disclosure provide a game interaction control method and apparatus, and an electronic device. This technology can be applied in games or other virtual scenes, and in particular, can be applied to the interaction control of combat strategy games.

The game interaction control method in one of the embodiments of the present disclosure may be run on a local terminal device or a server. When the game interaction control method is run on the server, the method may be implemented and executed based on a cloud interaction system, where the cloud interaction system includes a server and a client device.

In an optional implementation, various cloud applications, such as cloud games, may be run under the cloud interaction system. Taking cloud games as an example, cloud games refer to a game mode based on cloud computing. In the operation mode of cloud games, the operating body of the game program and the main body for presenting the game screen are separated. The storage and operation of the game display control method are completed on the cloud game server, and the client device is used for receiving and sending data as well as presenting the game screen. For example, the client device may be a display device close to the user side and having a data transmission function, such as a mobile terminal, a TV, a computer, a handheld computer, etc., while the cloud game server in the cloud is used for information processing.

When playing the game, the player operates the client device to send an operation instruction to the cloud game server, the cloud game server runs the game according to the operation instruction, encodes and compresses data like the game screen, and returns it to the client device through the network. Finally, the client device decodes and outputs the game screen.

In an optional implementation, taking a game as an example, a local terminal device stores a game program and is used for presenting a game screen. The local terminal device is used to interact with the player via a graphical user interface, that is, the game program is downloaded and installed by an electronic device and run conventionally. The local terminal device may provide the graphical user interface to the player in various ways, for example, the graphical user interface may be rendered and displayed on a display screen of the terminal, or provided to the player through a holographic projection. By way of example, the local terminal device may include a display screen and a processor, the display screen is used to present the graphical user interface, the graphical user interface includes a game screen, and the processor is used to run the game, generate the graphical user interface, and control the display of the graphical user interface on the display screen.

In a possible implementation, an embodiment of the present disclosure provides a game interaction control method, in which a graphical user interface is provided through a terminal device, where the terminal device may be the local terminal device mentioned above, or may be the client device in the cloud interaction system mentioned above. A graphical user interface is provided through the touch terminal device, and the graphical user interface may display interface content, such as a game scene screen, a communication interaction window, etc., according to the type of the application started. In this embodiment, a scene screen of a game scene is displayed in the graphical user interface, and the game scene includes a plurality of plot units. Players may construct city buildings and facilities such as main city or sub-cities on the plot units. At least a part of the plurality of plot units are non-enemy plots. In actual implementation, the non-enemy plots may be player-owned plots and allied plots, or may be only one of player-owned plots or allied plots.

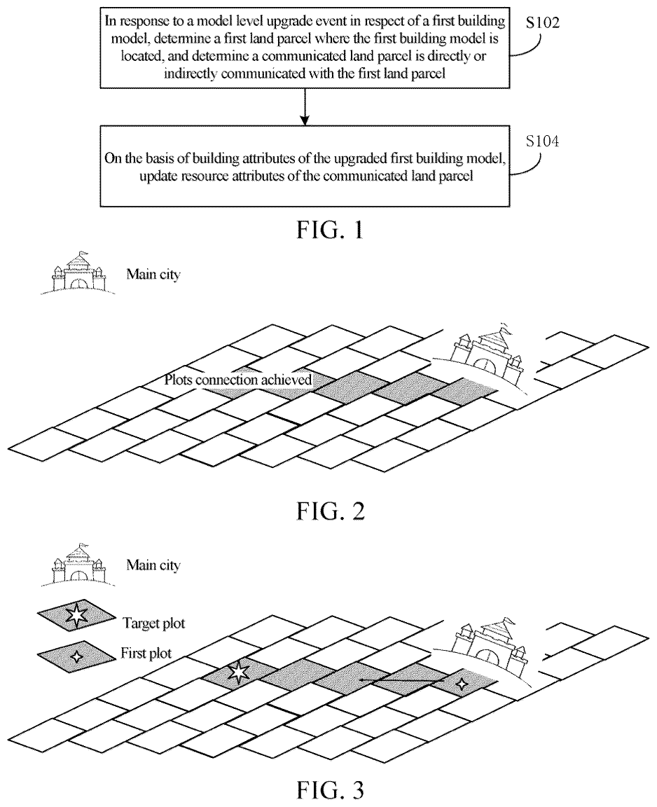

To facilitate understanding of this embodiment, a detailed introduction to a game interaction control method disclosed in an embodiment of the present disclosure is first provided. As shown in FIG. 1, a graphical user interface is provided via a terminal device, and a scene screen of a game scene is displayed in the graphical user interface. The game scene includes a plurality of plot units, and at least a part of the plurality of plot units has a first building model thereon.

During a game match, the plot units may be divided into: enemy plots and non-enemy plots, and the non-enemy plots include player-owned plots and allied plots; the first building model may be a city building model such as a main city, sub-city, etc. built by the player and/or the allies. The game interaction control method includes the following steps.

In step S102, in response to a model level upgrade event of the first building model, a first plot where the first building model is located is determined, and a connected plot of the first plot is determined; where the connected plot is directly or indirectly connected to the first plot.

The aforementioned first building model includes a city building model, such as a main city or a sub-city, etc., built by the player or allies on the plot. The first building model also has different levels. Generally speaking, the higher the level, the more resources the city building facility can obtain. The aforementioned first plot is the plot where the first building model is located, and the plot may be composed of one or more plot units.

When the model level of the first building model is upgraded, for example, the player consumes resources to upgrade the level of his/her main city or sub-city, in response to the model level upgrade event of the first building model, all plots that are directly or indirectly connected to the first plot are searched and determined among non-enemy plots through the first plot where the first building model is located.

In this step, after the model level of the first building model is upgraded, the first plot where the first building model is located and all plots directly or indirectly connected to the first plot are determined.

In step S104, a resource attribute of the connected plot is updated based on a building attribute of the upgraded first building model.

Many objects in the game scene represent resources, such as camps, equipment or soldiers, warehouses, and vegetation. Different plots may have different types of resources, such as military buildings, minerals, etc. Correspondingly, the resource attribute may refer to a level of building facility or the output of mineral materials. Players need to continuously acquire and upgrade resource attributes throughout the game and use resources at their disposal to develop their territories.

Similarly, the building attribute of the first building model include: a model level of the first building model, the level of related technology in the first building model, etc. When the attribute of the first building model is upgraded, the resource attributes of all plots directly or indirectly connected to the first plot determined in the above step are updated based on the upgraded building attribute of the first building model.

In this step, the change in the building attribute of the first building model is correlated with the resource attributes of the connected plots. When the building model in the scene is upgraded, the resource attributes of other plots connected to the plot where the building model is located will be updated. This manner can guide players to connect the occupied plots, increase players' interest in occupying low-level plots, thereby improving the utilization rate of the game scene map, and improving the utilization rate of computing resources of the terminal devices.

In the above game interaction control method, a graphical user interface is provided by a terminal device, the graphical user interface displays a scene screen of a game scene, the game scene includes a plurality of plot units, and at least a part of the plurality of plot units has a first building model thereon; where the method includes: in response to a model level upgrade event of the first building model, determining a first plot where the first building model is located, and determining a connected plot of the first plot; where the connected plot is directly or indirectly connected to the first plot; and updating a resource attribute of the connected plot based on a building attribute of the upgraded first building model. In this manner, after the building model in the scene is upgraded, the resource attribute of other plot connected to the plot where the building model is located is updated. This manner can guide players to connect the plots they have already occupied, increase players' interest in occupying low-level plots, thereby improving the utilization rate of the game scene map, and improving the utilization rate of the computing resources of terminal device.

In addition, the change in the resource attribute on a plot is also related to the connectivity state of the plot.

Specifically, in response to an increase in the connected plots, a target plot of which a connectivity state changes is determined from the connected plots; where the target plot transitions from a disconnected state to a directly or indirectly connected state with the first plot where the first building model is located.

The aforementioned connectivity state refers to a connectivity state between a plot and the plot where the first building model is located, which includes a directly connected state, an indirectly connected state, and a disconnected state. Direct connectivity means that a plot is adjacent to the plot where the first building model is located; indirect connectivity means that the plot may be connected to the plot where the first building model is located via a player-owned plot or an allied plot; and disconnected connectivity means that the plot cannot be connected to the plot where the first building model is located via the player-owned plot or the allied plot. During the game, the connectivity state between plots may change, which includes: transitioning from the directly or indirectly connected state to the disconnected state, or transitioning from the disconnected state to the directly or indirectly connected state. It is worth noting that the plot's influence on connectivity state is only related to its relative position to the plot where the first building model is located, and has nothing to do with the level of the plot.

In response to the increase in the connected plots, the connectivity state of the plot changes, and a target plot of which connectivity state changes is determined from the connected plots. Here, the target plot refers to a plot that transitions from a disconnected state to a directly or indirectly connected state with the first plot.

Furthermore, based on the building attribute of the first building model, a resource attribute of the target plot is updated; and prompt information indicating that the resource attribute of the target plot is updated is displayed.

Specifically, a search is performed for the first plot that is directly or indirectly connected to the target plot, the first building model is found, and according to the building attribute of the first building model, the resource attribute of the target plot is updated and prompt information indicating that the resource attribute is updated is displayed. The prompt information may take the form of one or more combinations of text prompts, displaying an icon, playing prompt sound, dynamic effects to indicate the change in resource attribute. For example, when the resource attribute of the target plot is promoted, an upward arrow icon is dynamically flashed on the target plot; when the resource attribute of the target plot is decreased, a downward arrow icon is dynamically flashed on the target plot.

In this manner, when the number of connected plots increases, according to the building attribute of the first building model, the resource attribute of the target plot is updated and prompt information is displayed. In this method, the change in the connectivity of the plot is correlated with the change in the resource attribute on the plot. Even low-level plots are capable of, through the manner of plots connectivity, increasing the resource building level and resource output of all target plots, thereby increasing players' interest in occupying low-level plots and further improving the utilization rate of the game scene map and the utilization rate of computing resources on the terminal device.

The following embodiments provide specific implementations for determining the target plot.

Here, there may be one or more target plots that affect the connectivity state with the first plot.

In one specific manner, in response to an occupation event of a second plot, it is determined that the second plot is directly or indirectly connected to the first plot, the second plot is then determined as a newly added connected plot, and the second plot is determined as a target plot of which the connectivity state has changed.

That is, when a new plot is occupied and is directly or indirectly connected to the first plot where the first building model is located, the new plot is determined as a newly added connected plot, that is, a target plot of which connectivity state has changed.

In another specific manner, in response to an occupation event of a second plot, the first plot where the first building model is located is determined; it is determined that the second plot is directly or indirectly connected to the first plot, and the second plot is connected to a third plot in a non-enemy plot. Before the occupation event of the second plot is triggered, the third plot is not connected to the first plot; the second plot and the third plot are then determined as newly added connected plots, and the second plot and the third plot are determined as target plots of which the connectivity states have changed.

The above-mentioned third plot may be a single non-enemy plot, or multiple non-enemy plots that are either adjacent to each other or connected via other non-enemy plot(s). Here, the second plot is adjacent to the third plot in the non-enemy plots, but the third plot is disconnected from the first plot where the first building model is located. Once the second plot is occupied by our side, the second plot becomes directly or indirectly connected to the first plot, then both the second and third plots can be directly or indirectly connected to the first plot. In this case, both the second plot and the third plot are target plots.

The above describes a method for determining the target plot(s) from non-enemy plots after a specified event is triggered. Furthermore, after determining the target plot, a special effect may be displayed for the connectivity state of the target plot to enrich the visual effect and increase the player's interest in connecting the plot.

The following embodiments provide specific implementations for displaying special effects for the target plot and related areas after the target plot is determined. It should be noted that, in actual implementation, one of the following special effect display modes may be used alone, or multiple display modes may be combined for display. Here, the target plot includes any newly added plot that is directly or indirectly connected to the first plot, and the newly added plot belongs to the non-enemy plot.

In a special effect display mode, the target plot is displayed in a first display format; the first display format is used to indicate that target plot transitions from the disconnected state to the directly or indirectly connected state with the first plot.

The first display format herein may be one or a combination of text prompt, prompt sound broadcast, pattern change in the target plot, and distinction in the color of the target plot. For example, FIG. 2 provides a schematic diagram of a first display format, where the first display format is in the form of text prompt, displaying a “plots connection achieved” text prompt on the target plot in the game scene, which indicates that the target plot and the first plot transition from a disconnected state to a directly or indirectly connected state. The area filled with oblique lines in the figure shows the plot occupied by the player and already connected to the first plot.

From the player's perspective, this area may also be displayed with special effect through prompt sound broadcast, pattern change in the target plot, and color of the plot.

In another special effect display mode, a preset dynamic model may also be controlled to move within a plot area that includes the target plot, where plots in the plot area are directly or indirectly connected to each other.

The aforementioned plot area containing the target plot may be understood as all plots, including the target plot, that are directly or indirectly connected to the first plot where the first building model is located. The aforementioned dynamic model is a movable object in a virtual environment. Depending on the different map scenarios, the movable object may be of various types such as virtual characters, virtual animals, and anime characters. In this manner, the preset dynamic model is controlled to move in a target plot area that includes the newly added plot(s).

Furthermore, in response to the dynamic model moving to a fourth plot in the plot area, and a road model being provided on the fourth plot, a model setting direction of the road model on the fourth plot is determined, and a moving direction of the dynamic model is determined based on the model setting direction; and the dynamic model is controlled to move along the moving direction.

That is, when the dynamic model moves to a plot provided with a road model in the target plot area, it is necessary to determine the model setting direction of the road model on the plot and control the moving direction of the dynamic model according to the model setting direction.

There is another special effect display mode, which requires determining a starting plot of a special effect from the scene screen. The starting plot of the special effect includes: the first plot, or an edge plot farthest from the target plot, where the edge plot is directly or indirectly connected to the first plot; and a preset flowing light special effect is controlled to start moving from the starting plot until reaching the target plot.

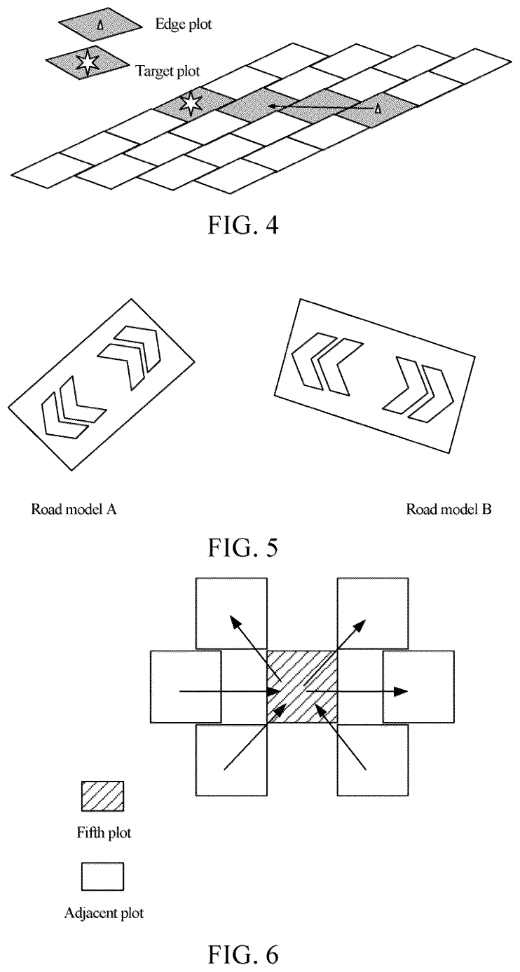

Specifically, it may be determined whether the first plot is within the scene screen according to Manhattan distance or Euclidean distance. The starting plot of special effect is determined according to the determination result, and the preset light flowing effect is controlled to move from the starting plot until it reaches the target plot. In one way, according to the determination result, it is determined that the first plot is within the scene screen of the display, then the starting plot of the special effect is the first plot. As shown in FIG. 3, the light flowing special effect is controlled to move from the first plot until it reaches the target plot. In another way, according to the determination result, it is determined that the first plot is not within the scene screen of the display, then an edge plot that is farthest from the target plot and is directly or indirectly connected to the first plot is searched for, and the edge plot serves as the starting plot of the special effect. As shown in FIG. 4, the preset light flowing special effect is controlled to move from the edge plot until it reaches the target plot.

The aforementioned special effect display modes enable brilliant visual effects to be presented after the player connect the plots, which enhances the gaming experience, boosts players' enthusiasm for occupying plots, and further improves the utilization rate of map in the game scene as well as the utilization rate of computing resources on the terminal device.

The following embodiments provide specific implementation manners for updating the resource attribute of the target plot.

Based on the building attribute of the first building model, a land resource yield of the target plot is updated, and a model level attribute of a second building model on the target plot is updated.

Here, the land resource yield of the target plot may be understood as the output of resources produced and obtained by using the target plot. For example, it includes the output of resources such as wood, iron ore, stone, and grain produced on the target plot. The model level attribute of the second building model on the target plot may refer to the level of the warehouse, mine, lumberyard, camp, and other building facilities built on the target plot. It can be understood that the higher the facility level and resource output, the more resources the player owns for developing the territories.

When the attribute of the first building model is updated, or the connectivity states of plots of the non-enemy plots change, the land resource yield of the target plot and the model level attribute of the second building model on the target plot are updated accordingly according to the model level of the first building model, the level of relevant technologies in the first building model, etc.

In this way, the connectivity state of plot is correlated with the resource attribute of the plot, which enriches the connectivity-based gameplay between plots, increases players' interest in occupying low-level resource plots, thereby improving the utilization rate of scene map, and at the same time improving the utilization rate of computing resources of the terminal device.

In war strategy games, most of them impose limitations on the number of plots a player can occupy, thereby reducing the players' enthusiasm for competing for plots. Based on this, the methods of the present disclosure further provide a direction for improvement.

Here, the first plot and the connected plot(s) are all non-enemy plots; the non-enemy plots include a first number of plots.

Specifically, the non-enemy plots include a first number of plots; a maximum number of plots is preset for the non-enemy plots. In response to a designated model placement operation on a fifth plot within the non-enemy plots, a designated building model is placed on the fifth plot; a second number of plots in the non-enemy plots is counted, where the fifth plot is not included in the plots corresponding to the second number of plots.

The first number is the number of non-enemy plots before the designated model placement operation is performed, and the second number is the number of non-enemy plots after the designated model placement operation is performed. The fifth plot refers to the plot on which the designated model placement operation is performed, and may be a non-enemy plot directly or indirectly connected to the first plot, or any other non-enemy plot.

In other words, there's a limit on the number of non-enemy plots that can be occupied. By performing the designated model placement operation on the non-enemy plots, a designated building model, such as those of construction facilities like roads and bridges, may be set up on the non-enemy plot. In this way, the plot is converted into a building facility such as a road or a bridge, and when counting the number of occupied non-enemy plots, the plot where the building facility is located is not included.

In this way, when placing the road model, it is necessary to determine the direction of the road model. Specifically, in response to the designated model placement operation on the fifth plot within the non-enemy plots, a plot state of an adjacent plot of the fifth plot is determined, and a model setting direction of the road model is determined according to the plot state. Then, the road model is placed on the fifth plot according to the model setting direction.

In actual implementation, the model setting direction may be determined according to a relative position of the adjacent plot to the fifth plot and the model setting direction of the road model on the adjacent plot, or the model setting direction may be determined according to either the relative position of the adjacent plot to the fifth plot or the model setting direction of the road model on the adjacent plot.

In one embodiment, as shown in FIG. 5, there are two types of preset road models, namely Model A and Model B, which indicate different directions, and the specific model to be used depends on the model setting direction. In one way, when a road facility model exists on an adjacent plot, a direction vector may be used to represent the model setting direction of the road model on the adjacent plot according to the relative position of the adjacent plot to the fifth plot.

The road model on the fifth plot is determined based on the direction vector calculation result.

For example, for a plot state as shown in FIG. 6, where the fifth plot is surrounded by six adjacent road facilities, direction vectors may be used to represent the model setting directions of the road models on the six surrounding plots. The road models are connected via unit vectors (for example: 1, 1 −1, 1 1, −1 . . . ), and all vectors are added to obtain one vector (x, y). If |x|≥|y|, model A is selected as the road model on the fifth plot; otherwise, model B is selected. In another way, if there is no road facility in the adjacent plot of the fifth plot, the model setting direction is determined by the relative position of the adjacent plot to the fifth plot. For example, when there is a non-enemy plot to the upper right of the fifth plot, the model setting direction is determined to be northeast, and model A is selected as the road model on the fifth plot.

In the above manners, by placing a designated building model on any non-enemy plot, the plot no longer occupies a spot in the player's total occupied plots quota. This allows the player to engage in plot-connecting gameplay without having to abandon their plots, expanding the scope of “coloring” (land coverage) and enhancing players' interest in interaction. In addition, the use of models of construction facility models such as roads and bridges authentically replicates the real-world concept of paving roads for resource transportation, which aligns with players' cognitive model of “to get rich, build roads first”.

To stimulate competition for land, the game also allows players to view the land connectivity states of other players. Specifically, plots that are directly or indirectly connected within non-enemy plots are displayed in a first display format; plots that are directly or indirectly connected within enemy plots are displayed in a second display format. Here, the first display format is different from the second display format.

The display format herein may be one or a combination of text prompt, prompt sound broadcast, change in pattern of the plot, and change in color of the plot, with the first display format being different from the second display format. In actual implementation, different display formats may also be used to differentiate the connectivity states of friend and enemy plots. In one embodiment, green is the color for plots that are directly or indirectly connected within player-owned plots, red is the color for plots that are directly or indirectly connected within enemy plots, and blue is the color for plots that are directly or indirectly connected within friend plots.

This method stimulates players to compete for land, thereby further promoting the improvement of utilization rate of the map in the game scene and the improvement of utilization rate of computing resources of the terminal device.

The embodiment further provides another specific implementation of the game interaction control method. Taking the game scene of an SLG game as an example, the interaction control process of the game is introduced in detail.
1) The player selects the plot to be connected, first performs the “Capture the plot” operation, and waits for the troops to occupy the plot.
2) After the troops have occupied a certain plot, when the non-enemy plot in the scene screen transitions from a disconnected state to a connected state, a connecting light flowing effect visible only to the player is played on the plot. Here, it is necessary to determine whether the main city or city of the alliance player closest to the occupied plot is within the scene screen of the display. Based on the determination result, there are two cases for the logic of playing the light flowing effect, which are as follows:
A. If the main city or city of the alliance player is within the scene screen, the plot where the alliance player's main city or city is located serves as the starting plot of the special effect. The preset light flowing special effect is controlled to move from this plot until it reaches the newly occupied plot.
B. If the main city or city of the alliance player is not within the scene screen, an edge plot, located within the screen, that is connected to the newly occupied plot and is the farthest away from the newly occupied plot is found and serves as the starting point, and the preset light flowing effect is controlled to move from the edge plot until it reaches the newly occupied plot.
3) After the light flowing effect finishes playing, a plot connection effect is played on the most recently connected plot, indicating that the plot has entered the “connected state”. At this point, a dynamically flickering “arrow” icon appears on the plot, signifying an increase in the resource output of the plot.
4) At the same time, when the plots are connected, a “transport team” composed of virtual animals appears on the connected plots and walk along the route. There may be different types of “transport teams” depending on the different map scenarios.
5) When a player-owned land plot outside of his field of view transitions from a disconnected state to a connected state, the plot is recorded as being in a “special effect not displayed” state.

When the plot enters the player's field of view for the first time, the display follows the following sequence: light flowing effect→plot connected effect→dynamically flickering “arrow” icon.
6) When the number of player's plots is affected by connected plots, any one of the low-level resource plots among the connected plots may be selected for “road” model construction.
7) After the road model placement operation is performed on any plot, the text “Road marker” is displayed on the plot, along with the corresponding road model.
8) To stimulate the gameplay of competition for plots among players, players in the game may view the connectivity states of other players' plots. There are three color states, where green represents the player, red represents enemies, and blue represents allies.

In addition, it may also be designed that the resource output of connected plots and the construction upper limit of road buildings increase as the level of relevant urban construction technology rises.

For example, it may be set as:
Level 1—Resource output increased by 15%, maximum number of road buildings is 5;
Level 2—Resource output increased by 18%, maximum number of road buildings is 10;
Level 3—Resource output increased by 21%, maximum number of road buildings is 20;
Level 4—Resource output increased by 23%, maximum number of road buildings is 35;
Level 5—Resource output increased by 25%, maximum number of road buildings is 50.

In this way, a non-mandatory purpose is assigned to the connectivity of plots, allowing players to rediscover the joy of “coloring”. The connectivity-based gameplay between plots is enriched, and players' interest in occupying low-level resource plots is increased, which improves utilization rate of map and further improves the utilization rate of computing resources of the terminal device.

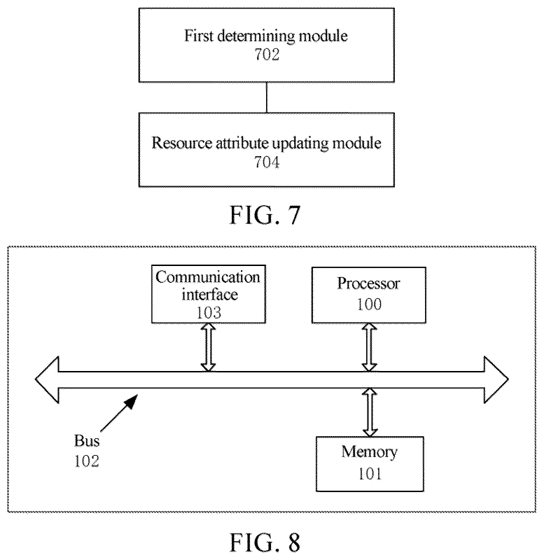

Corresponding to the above method embodiments, referring to the schematic diagram of a game interaction control apparatus as shown in FIG. 7, a graphical user interface is provided by a terminal device, the graphical user interface displays a scene screen of a game scene, the game scene includes a plurality of plot units, and at least a part of the plurality of plot units has a first building model thereon; where the apparatus includes:
a first determining module 702, configured to determine a first plot where the first building model is located and determine a connected plot of the first plot, in response to a model level upgrade event of the first building model; where the connected plot is directly or indirectly connected to the first plot; and
a resource attribute updating module 704, configured to update a resource attribute of the connected plot based on a building attribute of the upgraded first building model.

In this manner, when the building model in the scene is upgraded, the resource attributes of other plots connected to the plot where the building model is located are updated. This manner can guide players to connect the plots they have already occupied, increase players' interest in occupying low-level plots, thereby improving the utilization rate of the game scene map, and improving the utilization rate of the computing resources of terminal device.

Optionally, the game interaction control apparatus may further include a first display module, configured to determine, from the connected plots, a target plot of which a connectivity state changes in response to an increase in the connected plots; where the target plot transitions from a disconnected state to a directly or indirectly connected state with the first plot where the first building model is located; and update a resource attribute of the target plot based on the building attribute of the first building model; and display prompt information which indicates that the resource attribute of the target plot is updated.

Optionally, the first display module is further configured to, in response to an occupation event of a second plot, determine that the second plot is directly or indirectly connected to the first plot, determine the second plot as a newly added connected plot, and determine the second plot as the target plot of which the connectivity state changes.

Optionally, the first display module is further configured to, in response to an occupation event of a second plot, determine that the second plot is directly or indirectly connected to the first plot, and that the second plot is connected to a third plot; where before the occupation event of the second plot is triggered, the third plot is not connected to the first plot; and determine the second plot and the third plot as newly added connected plots, and determine the second plot and the third plot as the target plots of which connectivity states change.

Optionally, the game interaction control apparatus may include a second display module, configured to display the target plot in a first display format; where the first display format is used to indicate that the target plot transitions from the disconnected state to the directly or indirectly connected state with the first plot.

Optionally, the game interaction control apparatus may include a first control module, configured to control a preset dynamic model to move within a plot area that includes the target plot; where plots in the plot area are directly or indirectly connected to each other.

Optionally, the first control module is further configured to, in response to the dynamic model moving to a fourth plot in the plot area and a road model being provided on the fourth plot, determine a model setting direction of the road model on the fourth plot, and determine a moving direction of the dynamic model based on the model setting direction; and control the dynamic model to move along the moving direction.

Optionally, the game interaction control apparatus may include a second control module, configured to determine a starting plot of a special effect from the scene screen; where the starting plot of the special effect includes: the first plot, or an edge plot farthest from the target plot, the edge plot being directly or indirectly connected to the first plot; and control a preset flowing light special effect to start moving from the starting plot until reaching the target plot.

Optionally, the first display module is further configured to update a land resource yield of the target plot and update a model level attribute of a second building model on the target plot based on the building attribute of the first building model.

Optionally, the first plot and the connected plots belong to non-enemy plots, the non-enemy plots include plots of a first number, and a maximum number of plots is preset for the non-enemy plots. The game interaction control apparatus may include a first statistic module, configured to, in response to a designated model placement operation on a fifth plot within the non-enemy plots, place a designated building model on the fifth plot; and count a second number of the non-enemy plots; where plots corresponding to the second number do not include the fifth plot.

Optionally, the designated building model includes a road model; the first statistic module is further configured to determine a plot state of an adjacent plot of the fifth plot in response to the designated model placement operation on the fifth plot within the non-enemy plots; where the plot state includes: a relative position of the adjacent plot to the fifth plot, and/or a model setting direction of a road model on the adjacent plot; and determine a model setting direction of the road model based on the plot state; and place the road model on the fifth plot based on the model setting direction.

Optionally, the first plot and the connected plots belong to non-enemy plots; the game interaction control apparatus may include a third display module, configured to display plots that are directly or indirectly connected within the non-enemy plots in a first display format; and display plots that are directly or indirectly connected within enemy plots in a second display format; where the first display format is different from the second display format.

The present embodiment further provides an electronic device, including a processor and a memory, where the memory stores machine-executable instructions that can be executed by the processor, and the processor executes the machine-executable instructions to implement the above-mentioned game interaction control methods. The electronic device may be a server or a terminal device.

As shown in FIG. 8, the electronic device includes a processor 100 and a memory 101. The memory 101 stores machine-executable instructions that can be executed by the processor 100.

The processor 100 executes the machine-executable instructions to implement the game interaction control method.

Furthermore, the electronic device shown in FIG. 8 further includes a bus 102 and a communication interface 103, and the processor 100, the communication interface 103 and the memory 101 are connected via the bus 102.

The memory 101 may include a high-speed random access memory (RAM), and may also include a non-volatile memory, such as at least one disk memory. The communication connection between the system network element and at least one other network element is realized through at least one communication interface 103 (which may be wired or wireless), and the Internet, wide area network, local area network, metropolitan area network, etc. may be used. The bus 102 may be an ISA bus, a PCI bus or an EISA bus, etc. The bus may be divided into an address bus, a data bus, a control bus, etc. For ease of representation, only one bidirectional arrow is used in FIG. 8 for representation, but it does not mean that there is only one bus or one type of bus.

The processor 100 may be an integrated circuit chip with signal processing capabilities. In the implementation process, each step of the above methods may be completed by the hardware integrated logic circuit or instructions in software form in the processor 100. The above processor 100 may be a general-purpose processor, including a central processing unit (CPU), a network processor (NP), etc., it may also be a digital signal processor (DSP), an application specific integrated circuit (ASIC), a field-programmable gate array (FPGA), or other programmable logic devices, discrete gates or transistor logic devices, discrete hardware components, which can implement or execute the disclosed methods, steps and logic block diagrams in the embodiments of the present disclosure. The general-purpose processor may be a microprocessor or the processor may also be any conventional processor, etc. The steps of the methods disclosed in combination with the embodiments of the present disclosure may be directly embodied as being executed and completed by a hardware decoding processor, or may be embodied as being executed and completed by a combination of hardware and software modules in a decoding processor. The software module may be located in a random access memory, flash memory, read-only memory, programmable read-only memory or electrically erasable programmable memory, registers, and other mature storage media in the art. The storage medium is located in the memory 101, and the processor 100 reads the information in the memory 101 and completes the steps of the methods of the above embodiments in conjunction with its hardware.

The processor in the above-mentioned electronic device, by executing machine-executable instructions, can implement the following operations of the above game interaction control method: providing a graphical user interface through the terminal device; where a scene screen of the game scene is displayed in the graphical user interface; the game scene includes a plurality of plot units; and at least a part of the plurality of plot units has a first building model thereon. The method includes: in response to a model level upgrade event of the first building model, determining a first plot where the first building model is located, and determining a connected plot of the first plot; where the connected plot is directly or indirectly connected to the first plot; and updating a resource attribute of the connected plot based on a building attribute of the upgraded first building model.

In this manner, after the building model in the scene is upgraded, the resource attribute of other plot connected to the plot where the building model is located is updated. This manner can guide players to connect the plots they have already occupied, increase players' interest in occupying low-level plots, thereby improving the utilization rate of the game scene map, and improving the utilization rate of the computing resources of terminal device.

Optionally, the processor in the above-mentioned electronic device, through executing the machine-executable instructions, may implement the following operations of the game interaction control method: in response to an increase in the connected plots, determining, from the connected plots, a target plot of which a connectivity state changes; where the target plot transitions from a disconnected state to a directly or indirectly connected state with the first plot where the first building model is located; and updating a resource attribute of the target plot based on the building attribute of the first building model, and displaying prompt information which indicates that the resource attribute of the target plot is updated.

Optionally, the processor in the above-mentioned electronic device, through executing the machine-executable instructions, may implement the following operations of the game interaction control method: in response to an occupation event of a second plot, determining that the second plot is directly or indirectly connected to the first plot, determining the second plot as a newly added connected plot, and determining the second plot as the target plot of which the connectivity state changes.

Optionally, the processor in the above-mentioned electronic device, through executing the machine-executable instructions, may implement the following operations of the game interaction control method: in response to an occupation event of a second plot, determining that the second plot is directly or indirectly connected to the first plot, and that the second plot is connected to a third plot; where before the occupation event of the second plot is triggered, the third plot is not connected to the first plot; and determining the second plot and the third plot as newly added connected plots, and determining the second plot and the third plot as the target plot of which connectivity states change.

Optionally, the processor in the above-mentioned electronic device, through executing the machine-executable instructions, may implement the following operations of the game interaction control method: displaying the target plot in a first display format; where the first display format is used to indicate that the target plot transitions from the disconnected state to the directly or indirectly connected state with the first plot.

Optionally, the processor in the above-mentioned electronic device, through executing the machine-executable instructions, may implement the following operations of the game interaction control method: controlling a preset dynamic model to move within a plot area that includes the target plot; where plots in the plot area are directly or indirectly connected to each other.

Optionally, the processor in the above-mentioned electronic device, through executing the machine-executable instructions, may implement the following operations of the game interaction control method: in response to the dynamic model moving to a fourth plot in the plot area, and a road model being provided on the fourth plot, determining a model setting direction of the road model on the fourth plot, and determining a moving direction of the dynamic model based on the model setting direction; and controlling the dynamic model to move along the moving direction.

Optionally, the processor in the above-mentioned electronic device, through executing the machine-executable instructions, may implement the following operations of the game interaction control method: determining a starting plot of a special effect from the scene screen; where the starting plot of the special effect includes: the first plot, or an edge plot farthest from the target plot, the edge plot being directly or indirectly connected to the first plot; and controlling a preset flowing light special effect to start moving from the starting plot until reaching the target plot.

Optionally, the processor in the above-mentioned electronic device, through executing the machine-executable instructions, may implement the following operations of the game interaction control method: based on the building attribute of the first building model, updating a land resource yield of the target plot and updating a model level attribute of a second building model on the target plot.

Optionally, the first plot and the connected plot belong to non-enemy plots, the non-enemy plots include plots of a first number, and a maximum number of plots is preset for the non-enemy plots; the processor in the above-mentioned electronic device, through executing the machine-executable instructions, may implement the following operations of the game interaction control method: in response to a designated model placement operation on a fifth plot within the non-enemy plot, placing a designated building model on the fifth plot; and counting a second number of the non-enemy plots; where plots corresponding to the second number do not include the fifth plot.

Optionally, the designated building model includes a road model; the processor in the above-mentioned electronic device, through executing the machine-executable instructions, may implement the following operations of the game interaction control method: in response to the designated model placement operation on the fifth plot within the non-enemy plots, determining a plot state of an adjacent plot of the fifth plot; where the plot state includes: a relative position of the adjacent plot to the fifth plot, and/or a model setting direction of a road model on the adjacent plot; and determining a model setting direction of the road model based on the plot state; and placing the road model on the fifth plot based on the model setting direction.

Optionally, the first plot and the connected plots belong to non-enemy plots; the processor in the above-mentioned electronic device, through executing the machine-executable instructions, may implement the following operations of the game interaction control method: displaying plots that are directly or indirectly connected within the non-enemy plots in a first display format; and displaying plots that are directly or indirectly connected within enemy plots in a second display format; where the first display format is different from the second display format.

The present embodiment further provides a machine-readable storage medium, which stores machine-executable instructions. The machine-executable instructions, when being called and executed by a processor, cause the processor to implement the game interaction control method.

For the machine-executable instructions stored in the above-mentioned machine-readable storage medium, the following operations of the above game interaction control method may be implemented by executing the machine-executable instructions: providing a graphical user interface through the terminal device; where a scene screen of the game scene is displayed in the graphical user interface; the game scene includes a plurality of plot units; and at least a part of the plurality of plot units has a first building model thereon. The method includes: in response to a model level upgrade event of the first building model, determining a first plot where the first building model is located, and determining a connected plot of the first plot; where the connected plot is directly or indirectly connected to the first plot; and updating a resource attribute of the connected plot based on a building attribute of the upgraded first building model.

In this manner, after the building model in the scene is upgraded, the resource attributes of other plots connected to the plot where the building model is located are updated. This manner can guide players to connect the plots they have already occupied, increase players' interest in occupying low-level plots, thereby improving the utilization rate of the game scene map, and improving the utilization rate of the computing resources of terminal device.

Optionally, for the machine-executable instructions stored in the above-mentioned machine-readable storage medium, the following operations of the above game interaction control method may be implemented by executing the machine-executable instructions: in response to an increase in the connected plots, determining, from the connected plots, a target plot of which a connectivity state changes; where the target plot transitions from a disconnected state to a directly or indirectly connected state with the first plot where the first building model is located; and updating a resource attribute of the target plot based on the building attribute of the first building model, and displaying prompt information which indicates that the resource attribute of the target plot is updated.

Optionally, for the machine-executable instructions stored in the above-mentioned machine-readable storage medium, the following operations of the above game interaction control method may be implemented by executing the machine-executable instructions: in response to an occupation event of a second plot, determining that the second plot is directly or indirectly connected to the first plot, determining the second plot as a newly added connected plot, and determining the second plot as the target plot of which the connectivity state changes.

Optionally, for the machine-executable instructions stored in the above-mentioned machine-readable storage medium, the following operations of the above game interaction control method may be implemented by executing the machine-executable instructions: in response to an occupation event of a second plot, determining that the second plot is directly or indirectly connected to the first plot, and that the second plot is connected to a third plot; where before the occupation event of the second plot is triggered, the third plot is not connected to the first plot; and determining the second plot and the third plot as newly added connected plots, and determining the second plot and the third plot as the target plot of which connectivity states change.

Optionally, for the machine-executable instructions stored in the above-mentioned machine-readable storage medium, the following operations of the above game interaction control method may be implemented by executing the machine-executable instructions: displaying the target plot in a first display format; where the first display format is used to indicate that the target plot transitions from the disconnected state to the directly or indirectly connected state with the first plot.

Optionally, for the machine-executable instructions stored in the above-mentioned machine-readable storage medium, the following operations of the above game interaction control method may be implemented by executing the machine-executable instructions: controlling a preset dynamic model to move within a plot area that includes the target plot; where plots in the plot area are directly or indirectly connected to each other.

Optionally, for the machine-executable instructions stored in the above-mentioned machine-readable storage medium, the following operations of the above game interaction control method may be implemented by executing the machine-executable instructions: in response to the dynamic model moving to a fourth plot in the plot area, and a road model being provided on the fourth plot, determining a model setting direction of the road model on the fourth plot, and determining a moving direction of the dynamic model based on the model setting direction; and controlling the dynamic model to move along the moving direction.

Optionally, for the machine-executable instructions stored in the above-mentioned machine-readable storage medium, the following operations of the above game interaction control method may be implemented by executing the machine-executable instructions: determining a starting plot of a special effect from the scene screen; where the starting plot of the special effect includes: the first plot, or an edge plot farthest from the target plot, the edge plot being directly or indirectly connected to the first plot; and controlling a preset flowing light special effect to start moving from the starting plot until reaching the target plot.

Optionally, for the machine-executable instructions stored in the above-mentioned machine-readable storage medium, the following operations of the above game interaction control method may be implemented by executing the machine-executable instructions: updating a land resource yield of the target plot and updating a model level attribute of a second building model on the target plot based on the building attribute of the first building model.

Optionally, the first plot and the connected plots belong to non-enemy plots, the non-enemy plots include a first number of plots, and a maximum number of plots is preset for the non-enemy plots; for the machine-executable instructions stored in the above-mentioned machine-readable storage medium, the following operations of the above game interaction control method may be implemented by executing the machine-executable instructions: in response to a designated model placement operation on a fifth plot within the non-enemy plots, placing a designated building model on the fifth plot; and counting a second number of the non-enemy plots; where plots corresponding to the second number do not include the fifth plot.

Optionally, the designated building model includes a road model; for the machine-executable instructions stored in the above-mentioned machine-readable storage medium, the following operations of the above game interaction control method may be implemented by executing the machine-executable instructions: in response to the designated model placement operation on the fifth plot within the non-enemy plots, determining a plot state of an adjacent plot of the fifth plot; where the plot state includes: a relative position of the adjacent plot to the fifth plot, and/or a model setting direction of a road model on the adjacent plot; and determining a model setting direction of the road model based on the plot state; and placing the road model on the fifth plot according to the model setting direction.

Optionally, the first plot and the connected plots belong to non-enemy plots; for the machine-executable instructions stored in the above-mentioned machine-readable storage medium, the following operations of the above game interaction control method may be implemented by executing the machine-executable instructions: displaying plots that are directly or indirectly connected within the non-enemy plots in a first display format; and displaying plots that are directly or indirectly connected within enemy plots in a second display format; where the first display format is different from the second display format.

The game interaction control method and apparatus, the electronic device and computer program product of the storage medium provided in the embodiments of the present disclosure include a computer-readable storage medium storing program codes thereon. The instructions included in the program codes may be used to execute the methods described in the previous method embodiments. The specific implementation may refer to the method embodiments, which will not be repeated herein.

Those skilled in the art can clearly understand that, for the convenience and brevity of description, the specific working process of the system and apparatus described above may refer to the corresponding process in the aforementioned method embodiments, and will not be repeated herein.

In addition, in the description of the embodiments of the present disclosure, unless otherwise explicitly specified and limited, the terms “installed”, “connected”, and “connection” should be understood in a broad sense, for example, they may be a fixed connection, a detachable connection, or an integral connection; they may be a mechanical connection or an electrical connection; they may be a direct connection or indirect connection through an intermediate medium, or they may be the internal communication of two components. For those skilled in the art, the specific meanings of the above terms in the present disclosure may be understood according to specific circumstances.

If the functions are implemented in the form of software functional units and sold or used as independent products, they can be stored in a computer-readable storage medium. Based on this understanding, the essence of the technical solution, or the part that contributes to the related art or the part of the technical solution of the present disclosure, may be embodied in the form of a software product. The computer software product is stored in a storage medium, which includes several instructions to enable a computer device (which may be a personal computer, a server, or a network device, etc.) to perform all or part of the steps of the method described in each embodiment of the present disclosure. The aforementioned storage medium includes: a USB flash drive, a removable hard disk, a read-only memory (ROM), a random access memory (RAM), a disk or optical disk, and other media that can store program codes.

In the description of the present disclosure, it should be noted that the orientation or positional relationship indicated by the terms “center”, “upper”, “lower”, “left”, “right”, “vertical”, “horizontal”, “inner”, “outer”, etc., are based on the orientation or positional relationship shown in the accompanying drawings, and are only for the ease of describing the present disclosure and simplifying the description, rather than indicating or implying that the apparatus or element referred to must have a specific orientation, be constructed and operated in a specific orientation, and therefore cannot be understood as a limitation of the present disclosure. In addition, the terms “first”, “second”, and “third” are used for descriptive purposes only, and cannot be understood as indicating or implying relative importance.

Finally, it should be noted that the above embodiments are only specific implementation manners of the present disclosure, which are used to illustrate the technical solutions of the present disclosure, rather than to limit them. The protection scope of the present disclosure is not limited thereto. Although the present disclosure is described in detail with reference to the above embodiments, those skilled in the art should understand that any technician familiar with the technical field can still modify the technical solutions recorded in the foregoing embodiments, or easily think of changes, or make equivalent replacements for some of the technical features therein within the technical scope disclosed in the present disclosure, and these modifications, changes or replacements do not make the essence of the corresponding technical solutions deviate from the spirit and scope of the technical solutions of the embodiments of the present disclosure, and should be included in the protection scope of the present disclosure. Therefore, the protection scope of the present disclosure should be subject to the protection scope of the claims.

1. A game interaction control method, wherein a graphical user interface is provided by a terminal device, a scene screen of a game scene is displayed in the graphical user interface, the game scene comprises a plurality of plot units, and at least a part of the plurality of plot units has a first building model thereon; wherein the method comprises:
in response to a model level upgrade event of the first building model, determining a first plot where the first building model is located, and determining a connected plot of the first plot; wherein the connected plot is directly or indirectly connected to the first plot; and
updating a resource attribute of the connected plot based on a building attribute of an upgraded first building model.

2. The method according to claim 1, further comprising:
in response to an increase in a number of the connected plots, determining, from the connected plots, a target plot of which a connectivity state changes; wherein the target plot transitions from a disconnected state to a directly or indirectly connected state with the first plot where the first building model is located; and
updating a resource attribute of the target plot based on the building attribute of the first building model, and displaying prompt information which indicates that the resource attribute of the target plot is updated.

3. The method according to claim 2, wherein determining, from the connected plots, the target plot of which the connectivity state changes in response to the increase in the number of the connected plots comprises:
in response to an occupation event of a second plot, determining that the second plot is directly or indirectly connected to the first plot, determining the second plot as a newly added connected plot, and determining the second plot as the target plot of which the connectivity state changes.

4. The method according to claim 2, wherein determining, from the connected plots, the target plot of which the connectivity state changes in response to the increase in the number of the connected plots comprises:
in response to an occupation event of a second plot, determining that the second plot is directly or indirectly connected to the first plot, and that the second plot is connected to a third plot; wherein before the occupation event of the second plot is triggered, the third plot is not connected to the first plot; and
determining the second plot and the third plot as newly added connected plots, and determining the second plot and the third plot as the target plot of which connectivity states change.

5. The method according to claim 2, wherein after determining, from the connected plots, the target plot of which the connectivity state changes in response to the increase in the number of the connected plots, the method further comprises:
displaying the target plot in a first display format; wherein the first display format is used to indicate that the target plot transitions from the disconnected state to the directly or indirectly connected state with the first plot.

6. The method according to claim 2, wherein after determining, from the connected plots, the target plot of which the connectivity state changes in response to the increase in the number of the connected plots, the method further comprises:
controlling a preset dynamic model to move within a plot area that comprises the target plot; wherein plots in the plot area are directly or indirectly connected to each other.

7. The method according to claim 6, wherein controlling the preset dynamic model to move within the plot area that comprises the target land comprises:
in response to the dynamic model moving to a fourth plot in the plot area, and a road model being provided on the fourth plot, determining a model setting direction of the road model on the fourth plot, and determining a moving direction of the dynamic model based on the model setting direction; and
controlling the dynamic model to move along the moving direction.

8. The method according to claim 2, wherein after determining, from the connected plots, the target plot of which the connectivity state changes in response to the increase in the number of the connected plots, the method further comprises:
determining a starting plot of a special effect from the scene screen; wherein the starting plot of the special effect comprises: the first plot, or an edge plot farthest from the target plot, the edge plot being directly or indirectly connected to the first plot; and
controlling a preset flowing light special effect to start moving from the starting plot until reaching the target plot.

9. The method according to claim 2, wherein updating a resource attribute of the target plot based on the building attribute of the first building model comprises:
updating a land resource yield of the target plot and updating a model level attribute of a second building model on the target plot based on the building attribute of the first building model.

10. The method according to claim 1, wherein the first plot and the connected plot belong to non-enemy plots, the non-enemy plots comprise plots of a first number, and a maximum number of plots is preset for the non-enemy plots; wherein the method further comprises:
in response to a designated model placement operation on a fifth plot within the non-enemy plots, placing a designated building model on the fifth plot; and
counting a second number of the non-enemy plots; wherein plots corresponding to the second number do not comprise the fifth plot.

11. The method according to claim 10, wherein the designated building model comprises a road model; and placing the designated building model on the fifth plot in response to the designated model placement operation on the fifth plot within the non-enemy plots comprises:
in response to the designated model placement operation on the fifth plot within the non-enemy plots, determining a plot state of an adjacent plot of the fifth plot; wherein the plot state comprises at least one of: a relative position of the adjacent plot to the fifth plot, or a model setting direction of a road model on the adjacent plot; and
determining a model setting direction of the road model based on the plot state; and placing the road model on the fifth plot according to the model setting direction.

12. The method according to claim 1, wherein the first plot and the connected plot are non-enemy plots; wherein the method further comprises:
displaying plots that are directly or indirectly connected within the non-enemy plots in a first display format; and displaying plots that are directly or indirectly connected within enemy plots in a second display format; wherein the first display format is different from the second display format.

13. (canceled)

14. An electronic device, comprising: a processor and a memory, wherein a graphical user interface is provided by a terminal device, a scene screen of a game scene is displayed in the graphical user interface, the game scene comprises a plurality of plot units, and at least a part of the plurality of plot units has a first building model thereon; wherein the memory stores machine-executable instructions that can be executed by the processor, and the processor executes the machine-executable instructions to implement:
in response to a model level upgrade event of the first building model, determining a first plot where the first building model is located, and determining a connected plot of the first plot; wherein the connected plot is directly or indirectly connected to the first plot; and
updating a resource attribute of the connected plot based on a building attribute of an upgraded first building model.

15. A non-transitory computer-readable storage medium, wherein the non-transitory computer-readable storage medium stores machine-executable instructions, wherein a graphical user interface is provided by a terminal device, a scene screen of a game scene is displayed in the graphical user interface, the game scene comprises a plurality of plot units, and at least a part of the plurality of plot units has a first building model thereon; wherein the machine-executable instructions, when being called and executed by a processor, cause the processor to implement:
in response to a model level upgrade event of the first building model, determining a first plot where the first building model is located, and determining a connected plot of the first plot; wherein the connected plot is directly or indirectly connected to the first plot; and
updating a resource attribute of the connected plot based on a building attribute of an upgraded first building model.

16. The electronic device according to claim 14, wherein the processor is further configured to:
in response to an increase in a number of the connected plots, determine, from the connected plots, a target plot of which a connectivity state changes; wherein the target plot transitions from a disconnected state to a directly or indirectly connected state with the first plot where the first building model is located; and
update a resource attribute of the target plot based on the building attribute of the first building model, and display prompt information which indicates that the resource attribute of the target plot is updated.

17. The electronic device according to claim 16, wherein the processor is further configured to:
in response to an occupation event of a second plot, determine that the second plot is directly or indirectly connected to the first plot, determine the second plot as a newly added connected plot, and determine the second plot as the target plot of which the connectivity state changes.

18. The electronic device according to claim 16, wherein the processor is further configured to:
in response to an occupation event of a second plot, determine that the second plot is directly or indirectly connected to the first plot, and that the second plot is connected to a third plot; wherein before the occupation event of the second plot is triggered, the third plot is not connected to the first plot; and
determine the second plot and the third plot as newly added connected plots, and determine the second plot and the third plot as the target plot of which connectivity states change.

19. The electronic device according to claim 16, wherein the processor is further configured to:
after determining, from the connected plots, the target plot of which the connectivity state changes in response to the increase in the number of the connected plots, display the target plot in a first display format; wherein the first display format is used to indicate that the target plot transitions from the disconnected state to the directly or indirectly connected state with the first plot.

20. The electronic device according to claim 16, wherein the processor is further configured to:
after determining, from the connected plots, the target plot of which the connectivity state changes in response to the increase in the number of the connected plots, control a preset dynamic model to move within a plot area that comprises the target plot; wherein plots in the plot area are directly or indirectly connected to each other.

21. The electronic device according to claim 20, wherein the processor is further configured to:
in response to the dynamic model moving to a fourth plot in the plot area, and a road model being provided on the fourth plot, determine a model setting direction of the road model on the fourth plot, and determine a moving direction of the dynamic model based on the model setting direction; and
control the dynamic model to move along the moving direction.
